(19) United States
(12) Patent Application Publication
(10) Pub. No.: US 2006/0242905 A1
(43) Pub. Date: Nov. 2, 2006

(54) Fuel reformer and fuel reforming method

(76) Inventors: Hiroyuki Morioka, Tokyo (JP); Tsuyonobu Hatazawa, Tokyo (JP); Kazuhiro Noda, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/568,658

(22) PCT Filed: Aug. 13, 2004
(86) PCT No.: PCT/JP04/11946

§ 371 Date: Jun. 26, 2006

(30) Foreign Application Priority Data
Aug. 18, 2003 (JP) 2003-294356

(51) Int. Cl. C01B 3/26

(52) U.S. Cl. 48/198.1; 423/651; 48/127.9

(57) ABSTRACT

A fuel reforming apparatus and fuel reforming method capable of controlling activation of a catalyst by use of a simple arrangement and taking out hydrogen from a fuel gas is provided. A fuel fluid is passed to a catalyst passage formed with a catalyst unit, light is locally irradiated on the catalyst passage, and a hydrogen gas is taken out from the fuel fluid that is in contact with the catalyst unit in a region of the catalyst passage irradiated with the light. The light irradiated on the catalyst unit may be a laser beam, UV light or a combination of the laser beam and UV light. The region of the catalyst unit irradiated with the light may be changed to improve an efficiency of taking out the hydrogen gas, or an output of the light irradiated on the catalyst unit may be controlled to control an amount of hydrogen gas taken out from the fuel fluid.

### TECHNICAL FIELD

This invention relates to a fuel reforming apparatus and fuel reforming method wherein a hydrogen gas is taken out from hydrogen-containing fuels. More particularly, the invention relates to a fuel reforming apparatus and fuel reforming method for taking out a hydrogen gas from methanol for supply to fuel cells.

### BACKGROUND ART

A fuel cell is a power generating element where power is generated through electrochemical reaction between a fuel and oxygen (an oxidizer gas). Attention has now been paid to fuel cells because a product formed as a result of power generation consists of water and thus, no environmental pollution is involved. An attempt has been made, for example, for use as a drive power source for driving automobiles or co-generation systems for domestic purposes. Moreover, intensive developments have been made of fuel cells used not only as such a drive power source for driving automobiles as mentioned above, but also as a drive power source of portable electronic devices such as a laptop personal computer, a cell phone, PDA (personal digital assistant) and the like. In such a fuel cell, it is important that given electric power be stably outputted and it have a portable size and light weight. To meet this requirement, many technical developments have been extensively made.

Fuel cells are classified into various types depending on the types of electrolytes. Typically, a fuel cell using a solid polymer electrolyte as an electrolyte is known. A solid polymer electrolyte fuel cell can be made at low costs, is easy in miniaturization and weight reduction, and has a high output density in view of cell performance. Thus, this cell is promising, for example, when used in such applications as mentioned hereinabove. In addition, there has been proposed a fuel cell of a stacked type wherein a plurality power generation cells and separators are alternately stacked.

For a fuel used in power generation reaction, there have been proposed direct feed of hydrogen gas, a direct methanol system wherein a methanol aqueous solution is directly fed to a solid polymer electrolyte, a fuel reforming system where a hydrogen-containing fuel such as methanol is reformed to take out a hydrogen gas from the fuel (see, for example, Japanese Patent Laid-open No. 2003-146606). When comparing the feed of a fuel using a fuel reforming system with the case where a hydrogen gas is directly fed, the former is advantageous in that hydrogen necessary for the power generation reaction is taken out as required, with the easy in storage of the fuel and handling. Moreover, comparison with the direct methanol system reveals an advantage in that a higher electromotive force is obtained because of the use of hydrogen gas for the power generation reaction and that an adverse influence of methanol on a solid polymer electrolyte membrane can be avoided.

For the reforming method of a hydrogen-containing fuel gas, there are known a steam reformation reaction wherein the fuel gas is reacted with steam under heating conditions, a partial oxidation reaction wherein combustion is effected by means of an oxidizing agent, and a direct reaction wherein direction reaction with oxygen is carried out. In this connection, however, with hitherto proposed reforming reactions and reformers, heat sources are necessary for activation of catalyst, with attendant many problems in that a heat loss inevitably occurs for transmission of heat through partition walls, that the startup property is poor owing to the delay in thermal transmission necessary for the reforming reaction, and that a difficulty is involved in temperature control, so that a temperature inside a reforming vessel is liable to become locally high. In addition, incidental facilities such as a heat source and heat-insulating walls become necessary, thus lowering a degree of freedom for fuel cell designing lowers, with a difficulty involved in miniaturization.

Thus, the invention has for its object the provision of a fuel reforming apparatus and fuel reforming method wherein activation of a catalyst is appropriately controlled using a simple arrangement and hydrogen can be taken out from a fuel gas.

### DISCLOSURE OF INVENTION

In order to achieve the above object, a fuel reforming apparatus of the invention is of the type wherein a hydrogen gas is taken out from a hydrogen-containing fuel fluid, characterized by comprising a catalyst passage provided with a catalyst unit through which the fuel fluid runs in contact therewith, and local irradiation means for locally irradiating light against the catalyst passage.

Through the local light irradiation against the catalyst passage by means of the local irradiation means, the catalyst unit in a region where irradiated with light is activated, so that a hydrogen gas can be taken out from the fuel fluid that is in contact with the catalyst unit. The region on which light is irradiated by means of the local irradiation means is local. Thus, an activated portion of the catalyst unit formed in the catalyst passage is limited to the area irradiated with light and its vicinity, and a diffusion loss of heat to outside can be reduced and it becomes possible to lessen energy necessary for the activation of the catalyst. Since the diffusion loss of heat to outside is reduced, a heat quantity transmitted to an apparatus adjacent to the fuel reforming apparatus is also reduced, enabling the hydrogen gas to be taken out from the fuel fluid without a heat-insulating wall attached to the fuel reforming apparatus. Because of no necessity of attachment of a heat-insulating wall, it becomes possible to miniaturize the fuel reforming apparatus and improve the degree of design freedom. Moreover, a catalyst is activated by irradiation with light, so that a hydrogen gas can be taken out rapidly at the time of startup of the fuel reforming apparatus, thereby leading to an improved readiness.

The local irradiation means of the fuel reforming apparatus of the invention may be a laser emitting device capable of irradiating a laser beam or a UV light emitting device emitting UV light. If the local irradiation means emits a laser beam which locally irradiates a catalyst passage, a catalyst unit is heated at a region where irradiated with the laser beam, and a catalyst is locally activated, thereby enabling hydrogen gas to be taken out from the fuel fluid. Alternatively, when the local irradiation means emits UV light so as to locally irradiate the catalyst passage therewith, a hydrogen gas can be taken out from the fuel fluid at a region where irradiated with the UV light, thereby improving energy efficiency for taking out the hydrogen gas. Since the hydrogen gas is taken out through irradiation with a laser beam or UV light, local light irradiation can be realized by use of an existing, small-sized light emitting device, thus making it possible to miniaturize a fuel reforming apparatus in a simple way.

For the local irradiation means, both a laser beam emitting device capable of emitting a laser beam and a UV light emitting device emitting UV light may be provided. When activation of the catalyst unit by heating through laser beam irradiation and direct decomposition of a fuel fluid by UV light irradiation are used in combination, an efficiency of taking out a hydrogen gas from a fuel fluid is improved.

The local irradiation means may have irradiation changing means with which a region where irradiated with light can be changed, under which if a catalyst is partially degraded to worsen an efficiency of taking out hydrogen gas, this can be overcome by moving, within the catalyst passage, a region where irradiated with light. Additionally, a region where irradiated with light can be extended, so that it becomes possible to increase a region of activating a catalyst, thereby improving an efficiency of taking out hydrogen gas.

Further, since the local irradiation means may have output control means for controlling an output of light irradiated therefrom, the local irradiation means is enabled to change an output of light irradiation on a catalyst passage or to control a degree of activation of a catalyst by intermittent light irradiation. The control of light irradiation is easier than the control of a heat source for activating a catalyst through thermal conduction, and thus, it is more likely to control an amount of a hydrogen gas being taken out from a fuel fluid.

For solving the above problem, a fuel reforming method of the invention for taking out hydrogen gas from a hydrogen-containing fuel fluid is characterized by comprising passing the fuel fluid into a catalyst passage formed with a catalyst unit therein, and locally irradiating light against the catalyst passage to take out a hydrogen gas from the fuel fluid in contact with the catalyst unit in a region of the catalyst passage where irradiated with light.

The local light irradiation on the catalyst passage enables the catalyst unit in a region where irradiated with light to be activated and a hydrogen gas to be taken out from the fuel fluid brought into contact with the catalyst unit. The light irradiation region is local, so that an activated portion of the catalyst unit formed in the catalyst passage is limited only at a region where irradiated with light and a vicinity thereof. Accordingly, a loss of heat diffused to outside can be reduced and energy necessary for activation of catalyst can be lessened. Since the heat loss diffused to outside is reduced, a quantity of heat transmitted to outside can be reduced and thus, a hydrogen gas can be taken out from the fuel fluid without providing a heat-insulating wall. Because of no necessity for provision of a hat-insulating wall, it becomes possible to miniaturize a fuel reforming apparatus and improve a degree of design freedom therefor. Since a catalyst is activated through light irradiation, rapid collection of a hydrogen gas at the startup of the fuel reforming apparatus is possible, with readiness being thus improved.

### BRIEF DESCRIPTION OF DRAWINGS

FIG. 1 is a schematic view illustrating a structure of a fuel reforming apparatus according to a first embodiment of the invention;

FIG. 2 is a schematic view illustrating a structure of a fuel reforming apparatus according to a second embodiment of the invention; and

FIG. 3 is a schematic view illustrating a structure of a fuel reforming apparatus according to a third embodiment of the invention.

### BEST MODE FOR CARRYING OUT THE INVENTION

The fuel reforming apparatus and fuel reforming method to which the invention is applied are described in detail with reference to the drawings. It will be noted that the invention should not be construed as limiting to the following description, and alterations and variations may be appropriately possible without departing from the spirit of the invention. In the following description, use of methanol as a fuel fluid is illustrated, and hydrogen gas may be taken out by use of a hydrogen-containing fuel fluid including, aside from methanol, lower alcohols, methane or naphtha.

### Embodiment 1

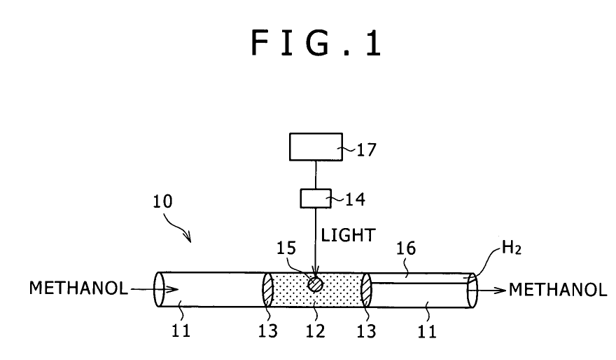

FIG. 1 is a schematic view illustrating a structure as showing a configuration example of a fuel reforming apparatus according to the invention. A fuel reforming apparatus 10 is one wherein a catalyst unit 12 is formed in a tubular fluid pipe 11, through which methanol used as a fuel fluid runs, for the purpose of facilitating decomposition reaction of the fuel fluid, a catalyst holding member 13 is formed at opposite ends of the catalyst unit 12, and light from light irradiation means 14 is irradiated against the fluid pipe 11 formed with the catalyst unit 12 therein. A region where irradiated with light from the light irradiation means 14 is depicted as an irradiation region 15, and the light irradiation means 14 is connected with output control means 17 that is so arranged as to control the output of light irradiation of the light irradiation means 14. At the downstream side of the catalyst unit 12 of the fluid pipe 11 as viewed in terms of the flow of the fuel fluid, a hydrogen recovery unit 16 is formed wherein a hydrogen gas separated from methanol at the catalyst unit 12 is taken out and recovered from the fuel fluid.

The fluid pipe 11 is made of a tubular member formed of a material having a corrosion resistance to methanol serving as a fuel fluid, and functions as a catalyst passage through which methanol runs. In FIG. 1, an instance of the fuel fluid in a cylindrical form and the shape may be appropriately changed. A U-shaped tubular or plate member formed with meander grooves may be provided as the fuel passage. Moreover, in FIG. 1, an instance is shown wherein methanol is charged outside of the fluid pipe 11 and discharged to outside. In this connection, such an arrangement may be used that the fuel fluid 11 is formed as having a circular structure wherein methanol is circulated.

Where the light irradiation means directly irradiates the catalyst unit 12 with light, it is necessary that the fluid pipe 11 be made of a material capable of transmitting light at least at a portion thereof where the catalyst unit 12 is formed.

The catalyst unit 12 is formed inside the fluid pipe 11 where it comes in contact with methanol and is activated by application of energy from outside, thereby causing the decomposition reaction of methanol to be facilitated and the hydrogen contained in methanol to be separated as a hydrogen gas. The material for forming the catalyst unit 12 may be one which is able to promote the decomposition reaction of the fuel fluid. Where methanol is used as a fuel fluid, the catalyst unit 12 may be made, for example, from a combination of a copper and zinc-based catalyst Cu/ZnO to which aluminum Al or chromium Cr is added, and a lead and zinc-based catalyst Pd/ZnO. Although the catalyst unit 12 may be formed on the inner wall surfaces of the fluid pipe 11, the surfaces of the catalyst unit 12 may be subjected to roughening so as to increase the area of contact with the fuel fluid. Alternatively, particles of a catalyst may be stacked to permit a fuel fluid to pass among the particles of the catalyst.

The catalyst holding member 13 is a member formed at opposite ends of the region where the catalyst unit 12 is formed and serves to prevent diffusion of the catalyst unit 12 toward the inside of the fluid pipe 11 and should have a function of passing the fuel fluid or a decomposed gas passing through the fluid pie 11. The material for the catalyst holding member 13 includes, for example, fibrous materials such as glass wool, porous materials and the like, and the catalyst holding member 13 is formed by packing glass wool inside the fluid pipe 11. Additionally, the hold member should be formed of a material that has a corrosion resistance to methanol serving as a fuel fluid.

The light irradiation means 14 is a device locally irradiating light on the fluid pipe 11 and has a function as local irradiation means. When a region of the fluid pipe 11 where irradiated with light is taken as an irradiation region 15, a smaller area of the irradiation region 15 enables one to make a higher density of energy transmitted by the light, resulting in a higher efficiency of activation of the catalyst unit. Accordingly, the light irradiation means 4 should preferably be constituted of a laser beam emission device so as to make a small optical diameter of irradiated light. Although the wavelength of irradiated light is not critical, it is preferred that light used is able to efficiently transmit energy to the fluid pipe 11 and the catalyst unit 12. The irradiated light may not be visible light, and UV light having a shorter wavelength and a high energy may be used instead.

Where a laser beam emitting device is used as the light irradiation means 14, laser beam emitting devices hitherto employed for recording information on an optical recording medium can be used. In these techniques, it is known that a recording material can be heated to about 900 K, which is a melting point thereof, by irradiation of a laser beam. With the fuel reforming apparatus of the invention, where methanol is used as a fuel fluid and a Cu/ZnO catalyst used as the catalyst unit 12, for example, the catalyst unit 12 is set within a temperature range of 500-600 K for the purpose of promoting the decomposition reaction thereby enabling the catalyst to be activated. Thus, when a laser beam emission device employed for optical recording medium is diverted to the light irradiation means 14 of the invention, it is considered possible to heat the catalyst unit 12 to an activation temperature.

The irradiation region 15 is one where the light irradiation means irradiates the fluid pipe 11 with light and in which energy is transmitted by means of the light. Eventually, the catalyst unit 12 is activated to promote the decomposition reaction of methanol serving as a fuel fluid. The activation of the catalyst unit at the irradiation region 15 is carried out by irradiating a laser beam on the fluid pipe 11 to locally heat the irradiation region 15. Where the light emitted from the light irradiation means 14 is a UV laser, methanol is considered to be directly decomposed at the irradiation region 15, thereby generating a hydrogen gas.

The hydrogen recovery unit 16 is formed downstream of the catalyst unit 12 of the fluid pipe 11 and is a member for separating and recovering, from methanol, a hydrogen gas generated by the decomposition reaction of methanol. The hydrogen recovery unit 16 is constituted, for example, of a branched pipe formed upwardly of the fluid pipe 11 as shown in FIG. 1, and hydrogen gas is recovered by utilizing the fact that a hydrogen gas runs upwardly of methanol as viewed along a gravity direction. The hydrogen gas recovered in the hydrogen recovery unit 16 is supplied to a fuel electrode side of a fuel cell for the purpose of power generation reaction.

The output control means 17 is a device which supplies electric power necessary for light emission to the light irradiation means 14 and controls the output of the light irradiation means. By the output control of the light irradiation means 14, many controls with respect to pulse light emission for intermittent light emission, an output change in continuous emission and adjustment of emission time may be carried out.

In the fuel reforming device of the invention, the light irradiation means 14 locally irradiates the fluid pipe 11 with a laser beam to activate the catalyst unit 12 at the irradiated region 15, at which methanol running through the fluid pipe 11 is decomposed to generate a hydrogen gas. The resulting hydrogen gas is withdrawn from the hydrogen recovery unit 16 and used for power generation reaction in a fuel cell. The light output from the light irradiation means 14 is controlled by the output control means 17, thus enabling the arriving temperature of the irradiation region 15 and the activation of the catalyst unit 12 to be controlled. The light irradiation is easier in control than in the case of activation of a catalyst through thermal conduction with use of a heat source, so that with the activation of catalyst by light irradiation, an amount of a hydrogen gas taken out from a fuel fluid can be more readily controlled.

Through the local light irradiation on the fluid pipe 11 by the light irradiation means 14, the catalyst unit 12 at the irradiation region 15 irradiated with light is activated, by which a hydrogen gas can be taken out from the fuel fluid in contact with the catalyst unit 12. The region irradiated with light from the light irradiation means 14 is local, and thus, the catalyst unit 12 formed inside the fluid pipe 11 is activated only at a region where irradiated with the light and surroundings thereof. Thus, a heat loss of diffused to outside can be reduced and energy necessary for activation of catalyst can be made small. Since the heat diffusion loss to outside can be reduced, a quantity of heat transmitted to an apparatus adjacent to the fuel reforming apparatus is reduced, and thus, a hydrogen gas can be taken out from a fuel fluid without setting up a heat-insulating wall to the fuel reforming apparatus. Because of no necessity for setting up a heat-insulating wall, it becomes possible to miniaturize a fuel reforming apparatus and improve a degree of freedom of design. Since a catalyst is activated by light irradiation, instantaneous temperature rise is possible, so that a hydrogen gas can be rapidly taken out at the startup of the fuel reforming apparatus, thereby improving readiness.

With the fuel reforming apparatus of the invention, the reforming of a fuel fluid is slight in degree, with the attendant heat generation being small in amount, so that the fuel reforming apparatus can be placed in the vicinity of a power generation unit of a fuel cell device, thereby enabling the fuel cell device to be miniaturized. Since the hydrogen gas can be taken out using a tubular fluid pipe, it is possible to improve a degree of freedom of design such as of setting up the fuel reforming apparatus in a space which has never been effectively employed inside an electronic device.

### Second Embodiment

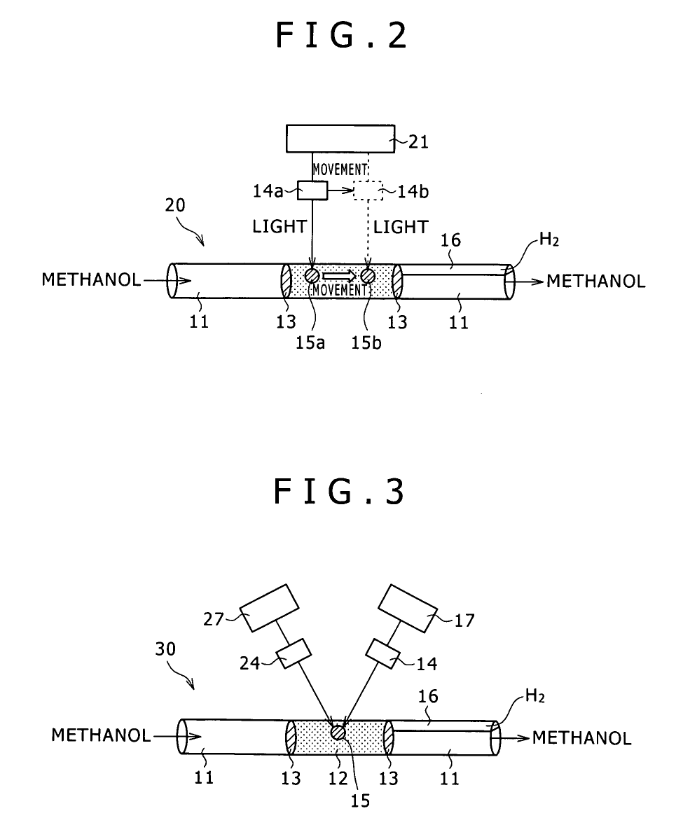

Next, an instance of changing the position of the light irradiation means is illustrated in FIG. 2 for another embodiment embodying a fuel reforming apparatus of the invention. FIG. 2 is a schematic view illustrating a structure of a fuel reforming apparatus according to the second embodiment. In this embodiment, like elements as in the first embodiment are indicated by like reference numerals and illustrations thereof are omitted.

A fuel reforming apparatus 20 is so arranged that a catalyst unit 12 for facilitating the decomposing reaction of a fuel fluid is formed in a tubular fluid pipe 11 through which methanol serving as a fuel fluid runs, a catalyst holding member 13 is formed at opposite ends of the catalyst unit 12, and light from light irradiation means 14 is irradiated on the fluid pipe 11 having the catalyst unit 12 formed therein. The apparatus is also so arranged that a region where light from the light irradiation means 14 is irradiated is indicated as an irradiation region 15, and the light irradiation means 14 is connected with irradiation change means 21 to change a position of the light irradiation means 14, thereby changing the irradiation region 15 where irradiated with light. At the downstream side of the catalyst unit 12 of the fluid pipe 11 as viewed along the flow of a fuel fluid, a hydrogen recovery unit 16 is formed and has such a structure as to take out and recover, from the fuel fluid, a hydrogen gas separated from methanol at the catalyst unit 12. Although not shown in FIG. 2, output control means 17 may be connected to the light irradiation means 14 so as to control the output of light emitted from the light irradiation means 14, like the first embodiment.

The irradiation change means 21 is connected to the light irradiation means 14 and is a device wherein a relative positional relationship between the light irradiation means 14 and the fluid pipe 11 is changed to change the position of the irradiation region 15 in the fluid pipe 11. For the irradiation change means 21, there may be used a linear motor, a belt-driven motor and the like. In case where a laser beam emitting device used to record information on an optical recording medium is used as the light irradiation means 14, a drive system at a pickup portion of the optical recording medium can be diverted. Since the irradiation change means may be one which is able to change the position of the irradiation region 15 on the fluid pipe 11, it may be possible to fix the light irradiation means 14 and change a path of light emitted from the light irradiation means by use of an optical member such as a reflection mirror.

As shown in FIG. 2, with the fuel reforming apparatus 20 according to this embodiment, the irradiation change means 21 changes the position of the light irradiation means 14 from 14a to 14b in the figure. The movement of the light irradiation means 14 changes the relative positional relationship between the light irradiation means 14 and the fluid pipe 11, with the attendant change in position of the fluid pipe 11 irradiated with light from the irradiation region 15a to 15b.

The positional change of the irradiation region 15 irradiated with light from the light irradiation means 14 by use of the irradiation change means 21 allows the decomposition reaction of methanol to be continued after movement of the irradiation region 15 on the fluid pipe 11 if the catalyst unit is partially degraded to worsen a taking-out efficiency of hydrogen gas. Moreover, where the catalyst unit 12 is activated by heating through light irradiation, the temperature of the irradiation region 15 is elevated to a given level, after which the position of the irradiation region 15 is changed to facilitate the decomposition reaction at a different position. In this way, a region where irradiated with light can be substantially extended and conduction of heat to other members can be suppressed to minimum. Thus, the region where the catalyst is activated can be increased in area without provision of a heat-insulating wall, thereby improving a taking-out efficiency of hydrogen gas.

### Third Embodiment

For a further embodiment embodying a fuel reforming apparatus of the invention, an instance wherein a plurality of light irradiation means are provided to emit light of different wavelengths is shown and illustrated in FIG. 3. FIG. 3 is a schematic view illustrating a structure of a fuel reforming apparatus according to the third embodiment. In this embodiment, like constituting elements as in the foregoing first embodiment are indicated by like reference numerals and illustrations thereof are omitted herein.

A fuel reforming apparatus 30 is one wherein a catalyst unit 12 for promoting the decomposition reaction of a fuel fluid is formed at a tubular fluid pipe 11, through which methanol serving as a fuel fluid runs, a catalyst holding member 13 is formed at opposite ends of the catalyst unit 12, and light from light irradiation means 14 and light irradiation means 24 is irradiated on the fluid pipe 11 forming the catalyst unit 12 therein. The region where light from the light irradiation means 14 and 24 is indicated as an irradiation region 15, and the light irradiation means 14, 24 are, respectively, connected to output control means 17, 27 to control the outputs of light emitted from the light irradiating means 14, 24. Although it has been set out hereinabove that the output control means 17, 27 are, respectively, connected to the light irradiation means 14, 24, the outputs of the light irradiation means 14, 24 may be controlled by the output control means 17 alone.

At the downstream side of the catalyst unit 12 of the fluid pipe 11 as viewed along the flow of the fuel fluid, a hydrogen recovery unit 16 is formed to have a structure wherein hydrogen gas separated from methanol at the catalyst unit 12 is taken out and recovered from the fuel fluid. Although not particularly sown in FIG. 3, irradiation change means 21 may be connected to the light irradiation means 14, 24, respectively, to change the positions of the light irradiation means 14, 24 thereby changing the irradiation region 15 where irradiated with light, like the second embodiment.

The light irradiation means 14 and the light irradiation means 24 provided for the fuel reforming apparatus 30 in this embodiment are a device for locally emitting light of different wavelengths against the fuel pipe 11 and function as local irradiation means. When a region where irradiated with light is taken as the irradiation region 15, a smaller area of the irradiation region 15 leads to a higher density of energy transmitted with light, resulting in more efficient activation of the catalyst unit 12. For instance, the light irradiation means 14 may be a laser beam emitting device emitting a visible light laser beam, and the light irradiation means 24 may be a laser beam emitting device emitting a UV light laser.

The UV light emitted from the light irradiation means 24 should directly irradiate the fuel fluid, not the fluid pipe 11, for which a lighting window through which light is transmitted is provided for the fluid pipe 11. The irradiation of methanol with a UV light laser beam causes such a reaction that methanol serving as a fuel fluid is directly decomposed into hydrogen gas. The light emitted from the light irradiation means 14 acts to heat the catalyst unit 12 at the irradiation region 15 of the fluid pipe 11, so that the catalyst unit 12 is activated to promote the decomposition reaction of methanol. When activation of the catalyst unit by heating through laser beam irradiation and direct decomposition of the fuel fluid by UV light irradiation are used in combination, an efficiency of taking out hydrogen gas from the fuel fluid is improved. Accordingly, the use of the direct irradiation of UV light and the heating by a laser beam in combination makes it possible to further reduce heat that generates upon taking-out of hydrogen gas. This further lowers the necessity of providing a heat-insulating wall, thereby enabling the fuel reforming apparatus to be miniaturized.

### INDUSTRIAL APPLICABILITY

The reforming apparatus is useful for various types of fuel fluids and makes a heat source unit necessary for activation of catalyst to be miniaturized and be controllable, with an attendant great advantage with respect to development of fuel cells. Moreover, the catalyst is activated through local light irradiation, so that the necessity for heat insulation can be significantly reduced. Because of no necessity of a heat-insulating wall, it becomes possible to miniaturize the fuel reforming apparatus and improve a degree of freedom of design. The catalyst is activated by light irradiation and hydrogen gas can be rapidly taken out at the time of start-up of the fuel reforming apparatus, thereby leading to improved readiness.

1. A fuel reforming apparatus for taking out a hydrogen gas from a hydrogen-containing fuel fluid, comprising:
a catalyst passage formed with a catalyst unit with which said fuel fluid runs in contact; and
local irradiation means for locally irradiating light on said catalyst passage.

2. The fuel reforming apparatus according to claim. 1, wherein said local irradiation means is a laser beam emitting device irradiating a laser beam.

3. The fuel reforming apparatus according to claim 1, wherein said local irradiation means is a UV light emitting device irradiating UV light.

4. The fuel reforming apparatus according to claim 1, wherein a laser beam emitting device irradiating a laser beam and a UV light emitting device irradiating UV light are provided as said local irradiation means.

5. The fuel reforming apparatus according to claim 1, wherein said local irradiation means has irradiation change means for changing a region where irradiated with light.

6. The fuel reforming apparatus according to claim 1, wherein said local irradiation means has output control means for controlling an output of light irradiated from said local irradiation means.

7. A method for reforming a fuel wherein a hydrogen gas is taken out from a hydrogen-containing fuel fluid, comprising:
passing said fuel fluid to a catalyst passage formed with a catalyst unit therein;
locally irradiating light on said catalyst passage; and
taking out a hydrogen gas from said fuel fluid that is in contact with said catalyst unit in a region of said catalyst passage where irradiated with the light.

8. The fuel reforming method according to claim 7, wherein the light irradiated on said catalyst unit is a laser beam.

9. The fuel reforming method according to claim 7, wherein the light irradiated on said catalyst unit is UV light.

10. The fuel reforming method according to claim 7, wherein a laser beam and UV light are used in combination as the light irradiated on said catalyst unit.

11. The fuel reforming method according to claim 7, wherein a region of said catalyst unit which is irradiated with the light is changed.

12. The fuel reforming method according to claim 7, wherein an output of the light irradiated on said catalyst unit is controlled to control an amount of hydrogen gs taken out from said fuel fluid.
